(19) United States
(12) Patent Application Publication
(10) Pub. No.: US 2026/0163001 A1
(43) Pub. Date: Jun. 11, 2026

(54) NANOPARTICLE-COMPOSITE LAYER FROM A CARBON SLURRY AND ANODELESS BATTERY HAVING THE NANOPARTICLE-COMPOSITE LAYER

(71) Applicant: SAMSUNG SDI CO., LTD., Yongin-si (KR)

(72) Inventors: Singyuk Hou, Cambridge, MA (US); Seungman Park, Yongin-si (KR); Hoyoung Lee, Cambridge, MA (US); Forrest Gittleson, Cambridge, MA (US); Yongseok Kim, Cambridge, MA (US)

(21) Appl. No.: 19/326,706

(22) Filed: Sep. 11, 2025

Related U.S. Application Data
(60) Provisional application No. 63/730,626, filed on Dec. 11, 2024.

(51) Int. Cl. H01M 4/62; H01M 4/02; H01M 4/04; H01M 4/66; H01M 4/75; H01M 10/0525; H01M 10/0562; H01M 10/647

(52) U.S. Cl. CPC H01M 4/622; H01M 4/0404; H01M 4/045; H01M 4/625; H01M 4/626; H01M 4/661; H01M 4/75; H01M 10/0525; H01M 10/0562; H01M 10/647; H01M 2004/021; H01M 2004/027

(57) ABSTRACT

A nanocomposite interlayer including a carbonaceous material, nanoparticles including metals or metalloids, at least one polymer binder, and a pH adjusting agent is provided. The carbonaceous material includes amorphous carbon, graphite, graphene, reduced graphene oxide, carbon nanotube, or combinations thereof. An anodeless battery including a positive electrode, a negative electrode current collector, the nanocomposite interlayer on the negative electrode current collector, and an electrolyte, and a method of operating the anodeless battery is also provided.

### CROSS-REFERENCE TO RELATED APPLICATION

This application claims priority to and the benefit of U.S. Provisional Patent Application Ser. No. 63/730,626, filed on Dec. 11, 2024, the entire disclosure of which is incorporated herein by reference.

### BACKGROUND AND FIELD

One or more embodiments of the present disclosure relate to a carbon film decorated with ultra-small metal and/or metalloid nanoparticles, a method of manufacturing the carbon film, an anodeless battery including the carbon film, and a method of operating the anodeless battery.

The carbon film is prepared from a slurry including a carbon-metal precursor in the presence of an acidic polymer binder, the slurry is applied to a negative electrode current collector and dried. The carbon film may be utilized as a negative electrode interlayer in the anodeless battery. For example, when used in an anodeless solid-state battery the carbon film may separate a solid-state electrolyte from a metal that is deposited on the negative electrode current collector to form a transitory negative electrode.

### SUMMARY

The present disclosure provides several advantages that include: novel polymer binders that provide novel polymer-metal composites; integration of slurry formation and nanoparticle synthesis into a single step thereby reducing processing costs; enhancing the utilization of the metal and/or metalloid nanoparticles by reducing the size to less than 10 nanometer (nm); lowering the over-potential for metal deposition; and enhancing the homogeneity, the rate performance at high rate, and cycling stability of the anodeless battery.

Further advantages provided by the present disclosure will be described herein but are not limited to the following description. Fourier transform infrared spectroscopy may provide a convenient method of detecting, analyzing, monitoring the acidic polymer binders. Manufacturing the carbon film with in-situ thermal induced decomposition from a solution phase slurry provides homogeneous distribution of nanoparticles across the carbon film, the negative electrode interlayer, and the negative electrode current collector. Reduced overpotential and enhanced utilization of the entire charge capacity of the anodeless battery, e.g., at low temperature and at high rate operating conditions.

One or more aspects of embodiments of the present disclosure are directed toward an anodeless battery including a positive electrode, a negative electrode current collector, a nanocomposite interlayer on the negative electrode current collector, and an electrolyte between the positive electrode and the nanocomposite interlayer. The nanocomposite interlayer includes a carbonaceous material, nanoparticles that include metals or metalloids, at least one polymer binder, and a pH adjusting agent. In one or more embodiments, the nanocomposite interlayer may be a carbon film decorated with ultra-small metal and/or metalloid nanoparticles (e.g., nanoparticles that include metals or metalloids).

One or more aspects of embodiments of the present disclosure are directed toward a nanocomposite interlayer including a carbonaceous material, nanoparticles that include metals or metalloids, at least one polymer binder, and a pH adjusting agent. The nanocomposite interlayer may be suitable for use in an anodeless battery.

One or more aspects of embodiments of the present disclosure are directed toward methods of operating the anodeless battery.

Additional aspects of embodiments will be set forth in part in the description which follows and, in part, will be apparent from the description, or may be learned by practice of the presented embodiments of the disclosure.

### BRIEF DESCRIPTION OF THE DRAWINGS

The patent or application file contains at least one drawing executed in color. Copies of this patent or patent application publication with color drawings will be provided by the Office upon request and payment of the necessary fee.

The preceding and other objects and features of embodiments of the present disclosure will become more apparent to those of ordinary skill in the art by describing example embodiments thereof in more detail with reference to the accompanying drawings. In the drawings:

FIG. 1A is a schematic view of a nanocomposite interlayer of the present disclosure in an anodeless battery before being operated according to one or more embodiments.

FIG. 1B is a schematic view of the anodeless battery in FIG. 1A with lithium being deposited during charging.

FIG. 1C is a schematic view of the anodeless battery in FIG. 1B after discharging of the anodeless battery.

FIG. 2A is a transmission electron microscopy (TEM) image of a nanocomposite interlayer of the present disclosure.

FIGS. 2B-2C are charts of X-ray powder diffraction (XRD) analysis of a nanocomposite interlayer of the present disclosure.

FIG. 3A is a TEM image of a nanocomposite interlayer of the present disclosure.

FIGS. 3B-3C are charts of XRD analysis of a nanocomposite interlayer of the present disclosure.

FIG. 4A is a TEM image of a comparative nanocomposite interlayer.

FIG. 4B is a chart of XRD analysis of a comparative nanocomposite interlayer.

FIGS. 5-6 are charts of the electrochemical performance of nanocomposite interlayers of the present disclosure and a comparative nanocomposite interlayer.

### DETAILED DESCRIPTION

In order to sufficiently understand the configuration and effect of embodiments of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, numbers, acts, tasks, elements, and/or a (e.g., any suitable) combination thereof.

In one or more embodiments, the term “layer” herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 200 particles at random in a transmission electron microscopic image.

The preceding and other objects and features of embodiments of the present disclosure will become more apparent to those of ordinary skill in the art by describing example embodiments thereof in more detail with reference to the accompanying drawings. In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

The following description includes non-limiting examples of values for quantities that are a part of the present disclosure. The example values are described as example ranges for the quantities and it will be understood that any and all of the following example ranges may include any sub-range beginning and/or ending with any value thereof. An example range of “about 60% to about 80%” may also include, for example, about 60.0% to about 75%, about 68% to about 80.0%, about 68% to about 72%, about 69.5% to about 70.5%, about 70.0%, and about 70%.

### Nanocomposite Interlayer

A nanocomposite interlayer according to one or more embodiments of the present disclosure includes a carbonaceous material, nanoparticles that include metals or metalloids, at least one polymer binder, and a pH adjusting agent. In one or more embodiments, the nanocomposite interlayer may be a carbon film decorated with ultra-small metal and/or metalloid nanoparticles (e.g., nanoparticles that include metals or metalloids).

In one or more embodiments, the carbonaceous material comprises amorphous carbon, graphite, graphene, reduced graphene oxide, carbon nanotube, or combinations thereof, and may be or include a carbon powder.

In one or more embodiments, the nanoparticles may be or include silver, gold, platinum, tellurium, antimony, germanium, bismuth, tin, tungsten, molybdenum, cobalt, nickel, copper, iron, alloys of at least two thereof, and combinations thereof.

In one or more embodiments, an average particle diameter (D50) of the nanoparticles may be at most about 10 nanometer (nm). For example, the average particle diameter (D50) of the nanoparticles may be about 0.5 nm to about 10 nm, about 1 nm to about 10 nm, about 1 nm to about 8 nm, about 1 nm to about 7 nm, about 1 nm to about 6 nm, about 1 nm to about 5 nm, about 1 nm to about 4 nm, about 1 nm to about 3 nm, about 1 nm to about 2 nm, about 2 nm to about 8 nm, about 2 nm to about 7 nm, about 2 nm to about 6 nm, about 2 nm to about 5 nm, about 2 nm to about 4 nm, about 2 nm to about 3 nm, about 3 nm to about 8 nm, about 3 nm to about 7 nm, about 3 nm to about 6 nm, about 3 nm to about 5 nm, about 3 nm to about 4 nm, about 4 nm to about 8 nm, about 4 nm to about 7 nm, about 4 nm to about 6 nm, or about 4 nm to about 5 nm.

In one or more embodiments, a weight ratio of an amount of the nanoparticles to an amount of the carbonaceous material may be about 1 to about 50. For example, the weight ratio of the nanoparticles to the carbonaceous material may be about 1 to about 40, about 1 to about 30, about 1 to about 20, about 1 to about 10, about 10 to about 100, about 10 to about 90, about 11 to about 89, about 20 to about 100, about 30 to about 100, about 40 to about 100, about 15 to about 90, or about 15 to about 85.

In one or more embodiments, a thickness of the nanocomposite interlayer may be about 1 micrometer (μm) to about 30 μm. For example, the thickness of the nanocomposite interlayer may be about 1 μm to about 25 μm, about 2 μm to about 20 μm, about 3 μm to about 15 μm, or about 4 μm to about 12 μm.

In one or more embodiments, the polymer binder may be represented by at one selected from among Formula (IA), Formula (IB), Formula (IC), and Formula (ID). For example, the polymer binder may be a co-block polymer including a scaffold unit, and at least one selected from among Formula (IA), Formula (IB), Formula (IC), and Formula (ID). The scaffold unit many include polyethylene glycol, polypropylene glycol, polydimethylsiloxane or a combinations thereof. For example, the scaffold unit many include at least two repeating units of polyethylene glycol, polypropylene glycol, polydimethylsiloxane or a combinations thereof.

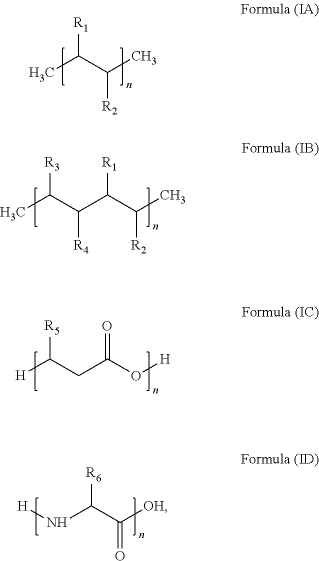

n may be an integer from 1 to about 200;
each R₁ may independently be —H, —COOH, —OH, —SO₃H, —BO₂H₂, —PO₃H₂, —C_{z}H_{2z+1}, —OC_{z}H_{2z+1}, —OC_{z}H_{2z}COOH, or Ar₁;

Ar₁ may be selected from among phenyl,

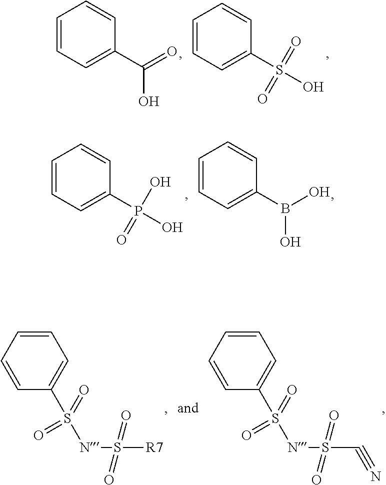

wherein a ring-forming carbon atom of Ar₁ not connected to a heteroatom or a carboxylate may be connected to Formula (IA) or (IB);
when R₁ is not —C_{z}H_{2z+1}, —OC_{z}H_{2z+1}, or phenyl, each R₂ may independently be —H or —COOH;
each R₃ may independently be —H, —OH, —OC_{z}H_{2z+1}, or phenyl;
when R₃ is —H, each R₄ may independently be —OH, —OC_{z}H_{2z+1}, or phenyl;
when R₃ is not —H, each R₄ is —H;
each R₅ may independently be —COOH, —SO₃H, —BO₂H₂, —PO₃H₂, or Ar₂;
Ar₂ may be selected from among

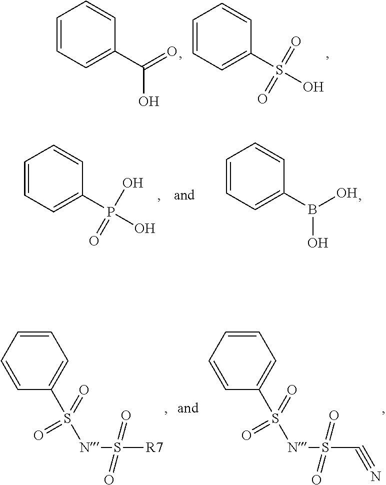

wherein a ring-forming carbon atom of Ar₂ not connected to a heteroatom or a carboxylate may be connected to Formula (IC);
R7 may be C_{z}X_{2z+1} and each X may independently be H, F, Cl, or Br,
z may be greater than or equal to 1;
each R₆ may independently be —CₘH₂ₘCOOH, —CₘH₂ₘCONHCₚH₂ₚCOOH, —CₘH₂ₘCONH₂, or —CₚH₂ₚNH₂, each m may independently be 1 or 2, and each p may independently be greater than or equal to 1.

In one or more embodiments, the polymer binder may be polyacrylic acid, polymethacrylic acid, polymaleic acid, polyglutamic acid, polyitaronic acid, polystyrene carboxylic acid, poly(methyl vinyl ether-alt-maleic acid), poly(styrene-alt-maleic acid), poly(malic acid), poly(metaphosphoric acid), polyvinyl sulfonic acid, polystyrene sulfonic acid, poly(styrene sulfonic acid-alt-maleic acid), poly(vinyloxy-4-butyric acid), poly(vinyl-phenyl boronic acid), or a combination thereof.

In one or more embodiments, the polymer binder may have an average molecular weight of at least about 60,000 Dalton (D).

In one or more embodiments, the pH adjusting agent may be or include a base. For example, the pH adjusting agent may be or include a hydroxide of a metal selected from Group 1 or Group 2 of the Periodic Table of Elements. In one or more embodiments, the pH adjusting agent may be or include LiOH—H₂O.

In one or more embodiments, the negative electrode current collector may include a metal foil including stainless steel, iron, nickel, manganese, copper, titanium, aluminum, or combinations thereof. In one or more embodiments, the negative electrode current collector includes an amount of unspecified trace elements of less than about 1%.

### Method of Preparing the Nanocomposite Interlayer

Methods of manufacturing a nanocomposite interlayer according to one or more embodiments of the present disclosure include mixing a soluble metal precursor, a carbonaceous material, a polymer binder, a pH adjusting agent, and a solvent. The methods include formation of a complex of the soluble metal precursor and polymer binder. For example, the soluble metal precursor, the polymer binder, and the solvent may be combined to form a pre-solution that may be added to the carbonaceous material. In one or more embodiments, a mixture of the pre-solution and the carbonaceous material may be mixed with agitation sufficient to provide the slurry as a homogeneous and flowable slurry that includes the complex. For example, the pre-solution and the carbonaceous material may be mixed in a centrifugal mixer or planetary mixer. For example, a mixing speed may at least about 1000 rpm.

In one or more embodiments, the soluble metal precursor may include a metal cation selected from among silver, gold, platinum, tellurium, antimony, germanium, bismuth, tin, tungsten, molybdenum, cobalt, nickel, copper and a combination thereof, and an anion selected from among nitrate, nitrite, thiosulfate, hydroxide, carbonate, acetate, oxalate, maleate, and a combination thereof. For example, the soluble metal may include AgNO₃, e.g., aqueous AgNO₃.

In one or more embodiments, the solvent may be water, ethanol, isopropanol, N-methyl-2-pyrrolidne (NMP) or a combination thereof.

The methods include applying (e.g., coating) the slurry to a negative electrode current collector, e.g., the slurry may be applied using spin cast, tape casting, and/or roll-to-roll coating technology.

The methods include drying the slurry to reduce the complex and form the nanoparticles and a nanocomposite interlayer that includes the carbonaceous material and the nanoparticles. For example, the metal cations may be reduced by the reducing moieties on functional groups of the polymer binder and the size of the nanoparticles and may be set or determined by the reducing action of the polymer binder. In some embodiments, the slurry may be dried at a temperature of about 100° C. to about 160° C. and for about 5 min to about 24 hours.

The methods may provide a one-pot route to a carbon-metal slurry having ultra-small metal particles (e.g., the nanocomposite interlayer including the carbonaceous material and the nanoparticles comprising metals or metalloids).

### Anodeless Battery

A battery according to one or more embodiments of the present disclosure includes a positive electrode, a negative electrode current collector, the nanocomposite interlayer on the negative electrode current collector, and an electrolyte between the positive electrode and the nanocomposite interlayer. In one or more embodiments, the battery may be an anodeless battery, for example, an anodeless rechargeable lithium battery. The term “anodeless battery” as used herein is a battery that excludes a permanent anode and may include a transitory negative electrode, as described in more detail elsewhere herein. For example, the transitory negative electrode may occur, or otherwise be arranged, between the nanocomposite interlayer and the negative electrode current collector. The anodeless battery (e.g., anodeless rechargeable lithium battery) of the present disclosure may be applied in vehicles, electric vehicles, mobile phones, suitable electrical devices, and/or the like but the present disclosure is not limited thereto.

In one or more embodiments, the nanocomposite interlayer may be arranged between the negative electrode current collector and the electrolyte.

### Solid Electrolyte

In one or more embodiments, the anodeless battery may be a solid-state (e.g., all-solid) anodeless battery, (e.g., solid-state (e.g., all-solid) anodeless rechargeable lithium battery), and the electrolyte may include a solid (e.g., all-solid) electrolyte. The solid electrolyte may include any material suitable for use as an ion conductive material, non-limiting examples of which include an inorganic solid electrolyte, a crystalline solid electrolyte, an amorphous solid electrolyte, a polymeric solid electrolyte, or a combination thereof. The solid electrolyte may be, for example, a sulfide-based solid electrolyte, an oxide-based solid electrolyte, a lithium aluminum titanium phosphate (LATP) solid electrolyte, an anti-perovskite solid electrolyte, or a combination thereof. The sulfide-based solid electrolyte may include, for example, Li, S, and P and may optionally further include a halogen element. The sulfide-based solid electrolyte may be selected from sulfide-based solid electrolytes utilized in an electrolyte layer. For example, the sulfide-based solid electrolyte may have an ionic conductivity of at least about 1×10⁻⁵ Siemens per centimeter (S/cm) at room temperature. The oxide-based solid electrolyte may include, for example, Li, O, and a transition metal element and may optionally further include other elements. For example, the oxide-based solid electrolyte may be a solid electrolyte having an ionic conductivity of at least about 1×10⁻⁵ S/cm at room temperature. The oxide-based solid electrolyte may be selected from oxide-based solid electrolytes suitable for use in an electrolyte layer.

In one or more embodiments, the solid electrolyte may include at least one selected from among Li₂S—P₂S₅, Li₂S—P₂S₅—LiX, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, Li₂S—GeS₂, Li₂S—SiS₂—Li₃PO₄, Li₂S—SiS₂-LiₚMO_{q}, and a combination thereof. For example, X may be a halogen, Z may be Ge, Zn, or Ga, M may be P, Si, Ge, B, Al, Ga, or In, and m, n, p, and q may each independently be a positive integer.

### Electrolyte Solution

In one or more embodiments, the anodeless battery may be an anodeless rechargeable lithium battery that includes an electrolyte solution. For example, the electrolyte solution may include a non-aqueous organic solvent and a lithium salt. The non-aqueous organic solvent may be a carbonate-based, ester-based, ether-based, ketone-based, and/or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In some embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, or an ether group, and/or the like); amides such as dimethylformamide; dioxolanes such as 1,3-dioxolane, 1,4-dioxolane, and/or the like; sulfolanes, and/or the like.

The non-aqueous organic solvent may be used alone or in a mixture of two or more types (kinds), and if two or more kinds are used in a mixture, a mixing ratio may be appropriately or suitably adjusted according to the desired or suitable battery performance.

If using a carbonate-based solvent, a cyclic carbonate and a chain carbonate may be mixed and used, and the cyclic carbonate and the chain carbonate may be mixed in a volume ratio of about 1:1 to about 1:9.

The non-aqueous organic solvent may further include an aromatic hydrocarbon-based organic solvent. For example, a carbonate-based solvent and an aromatic hydrocarbon-based organic solvent may be mixed and used in a volume ratio of about 1:1 to about 30:1.

The electrolyte solution may further include vinylethyl carbonate, vinylene carbonate, and/or an ethylene carbonate-based compound to improve battery cycle-life.

Examples of the ethylene carbonate-based compound may include fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent provides lithium ions in a battery, enables a basic operation of a rechargeable lithium battery, and improves transportation of the lithium ions between positive and anodes. Examples of the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

A concentration of lithium salt may be within the range of about 0.1 M to about 2.0 M. If the concentration of lithium salt is within the described range, the electrolyte solution has appropriate or suitable ionic conductivity and viscosity, and thus excellent or suitable performance may be achieved and lithium ions may move effectively.

### Method of Operating an Anodeless Battery

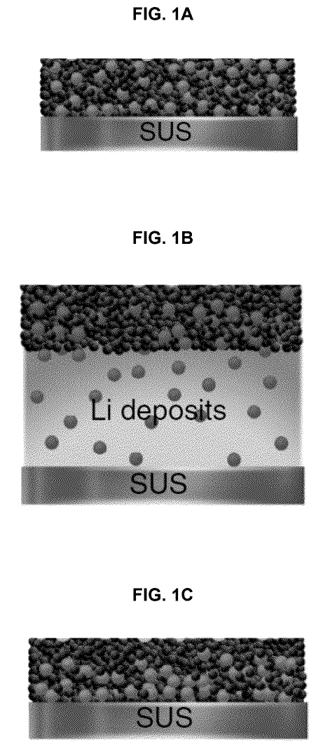

Methods of operating an anodeless battery according to one or more embodiments of the present disclosure include charging the battery to form a transitory negative electrode between the nanocomposite interlayer and the negative electrode current collector. FIG. 1A shows the nanocomposite interlayer on a negative electrode current collector (nickel-coated copper or SUS) of the anodeless battery before being operated. FIG. 1B shows a transitory negative electrode (“Li deposits”) being deposited on the negative electrode current collector (nickel-coated copper or SUS) during charging of the anodeless battery. The methods include discharging the battery to remove the transitory negative electrode. FIG. 1C shows an absence of the transitory negative electrode during and/or after discharging of the anodeless battery.

In one or more embodiments, the transitory negative electrode may include metal elements, metal alloys, metal compounds, or a combination thereof. For example, the transitory negative electrode may include lithium metal, lithium alloys, lithium compounds, or combinations thereof.

### EXAMPLES

### Example 1

A mixture was prepared by adding 3.1 g pre-solution including a polymer binder to 1 g of a carbon powder. The pre-solution included a soluble metal precursor in an amount suitable to provide the ratio of metal to carbon described in Examples 1.1 and 1.2. The mixture was mixed in a planetary centrifugal mixer at 2000 rpm for 3 min to generate a homogeneous and flowable slurry. A thin layer of the slurry was cast onto a Ni-coated Cu current collector and dried at a temperature of about 100° C. to about 150° C. for about 5 min to about 24 hours to provide a nanocomposite interlayer on a negative electrode current collector as described in Examples 1.1 and 1.2.

### Example 1.1

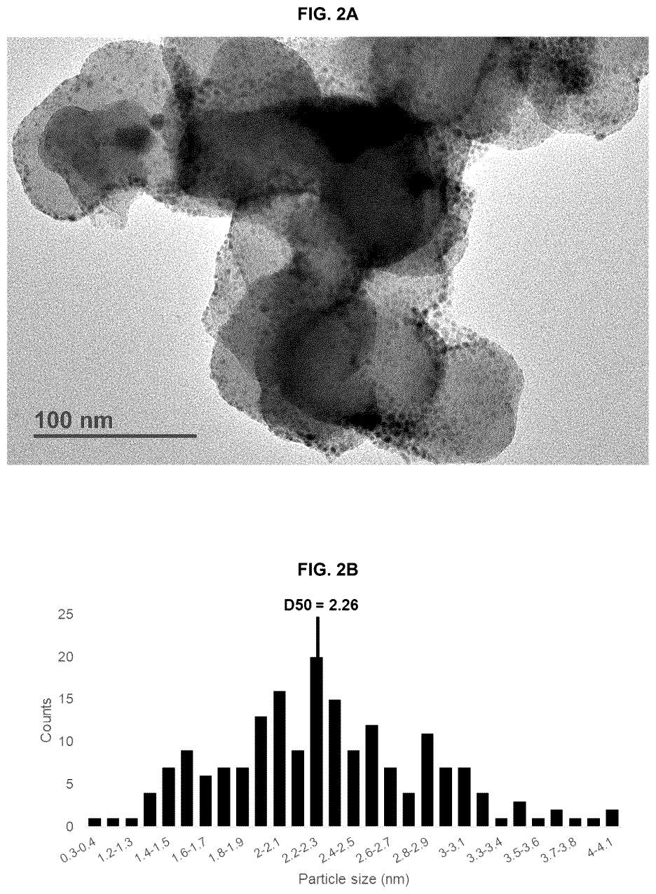

The soluble metal precursor was silver nitrate (AgNO₃) and the pre-solution included 5 wt % poly(methyl vinyl ether-alt-maleic acid) (PMVEMA) and 0.7 M aqueous AgNO₃. The drying temperature was 120° C. for 2 hours. The nanocomposite interlayer synthesized thereby had a ratio of metal to carbon (Ag:C) of 15:85 and included Ag nanoparticles (AgNP) having an average particle diameter (D50) of 2.26 nm as determined by transmission electron microscopy (TEM) (FIG. 2A-2B). The synthetic yield regarding Ag was 100% as determined by the absence of AgNO₃ related patterns in XRD (FIG. 2C).

### Example 1.2

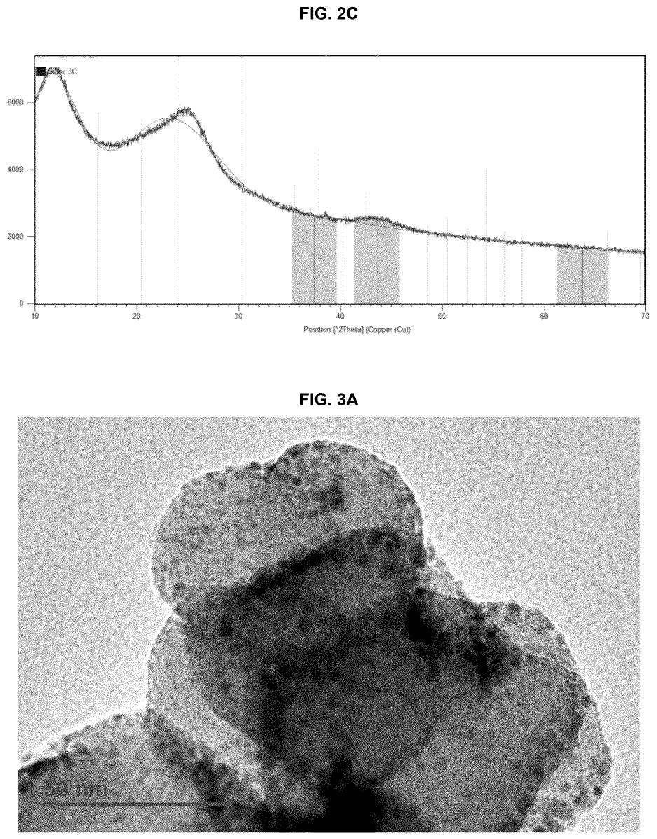

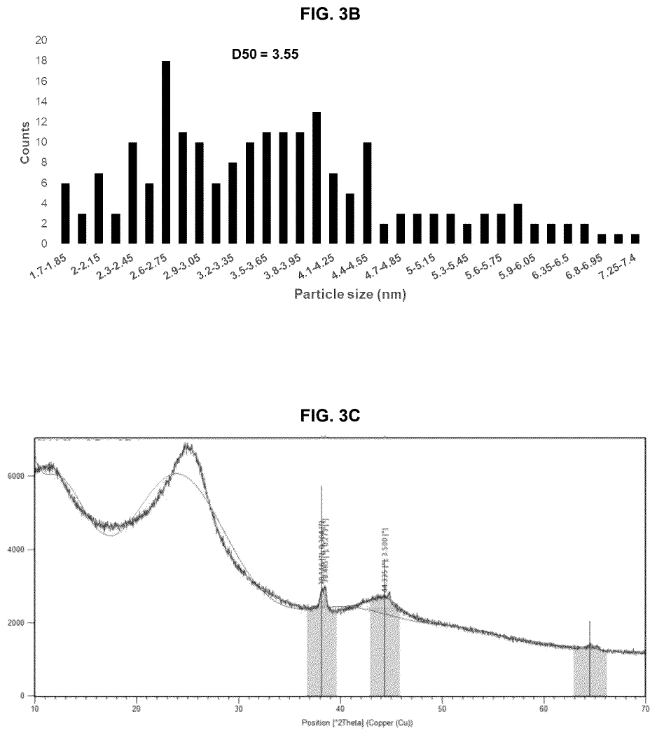

The soluble metal was silver (Ag) and the pre-solution included 3.3 wt % polystyrene sulfonic acid (PSSA) and 0.7 M aqueous AgNO₃. The drying temperature was 120° C. for 2 hours. The nanocomposite interlayer synthesized thereby had a ratio of metal to carbon (Ag:C) of 15:85 and included AgNP having an average particle diameter (D50) of 3.55 nm as determined by transmission electron microscopy (TEM) (FIGS. 3A-3B). The synthetic yield regarding Ag was about 100% as determined by XRD (FIG. 3C).

### Example 2: Preparation of Pouch Cells

The nanocomposite interlayers prepared in Examples 1.1 and 1.2 were compressed with a tape casted solid electrolyte film including at least one solid-state electrolyte of the present disclosure and a positive electrode film including LiNi_{w}MnₓCo_{y}Al_{z}O₂ (w+x+y+z=1, w>0.8) as a positive electrode active material. The compressed layers were assembled in pouch cells and operated under stack pressure of less than 2 megapascals (MPa).

### Comparative Example

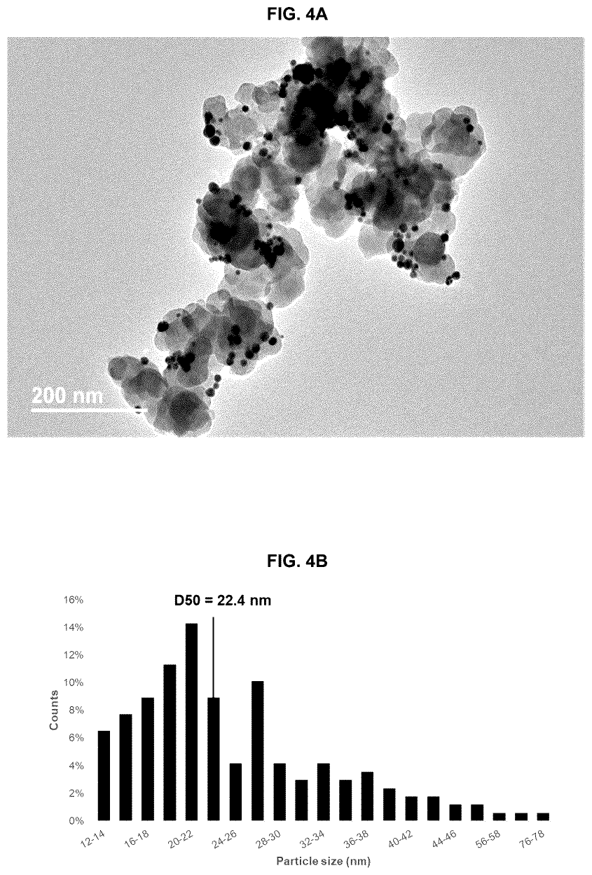

A Comparative Example included Ag nanoparticle decorated carbon with an average Ag nanoparticle size (D50) of 22 nm (FIGS. 4A-4B). The binder included a mixture of carboxymethyl cellulose and styrene-butadiene rubber to form the interlayer.

### Example 3: Evaluation

Rate tests of the pouch cells prepared in Example 2 were performed as follows. The pouch cells were charged at a constant current of 0.1 C rate (1 C=fully charge/discharge the battery in 1 hour) to 4.25 V, followed by a constant voltage step at 4.25V until the current reached 0.05 C. The pouch cells were then discharged at rates of 0.1 C, 0.33 C and 1 C to 2.5 V following the same charging protocol, the operating temperature was 25° C.

Cycling tests of the pouch cells prepared in Example 2 were performed as follows. The pouch cells were charged at a constant current of 0.1 C to 4.25 V, followed by a constant voltage step at 4.25V until the current reached 0.05 C, and then discharged at 0.1 C to 2.5V. This procedure was repeated once as formation cycles. The cycle was charged at a constant current at 0.33 C followed by a constant voltage step at 4.25 V until the current reached 0.177 C, then the cell was discharged at 0.33 C to 2.5V for 50 cycles.

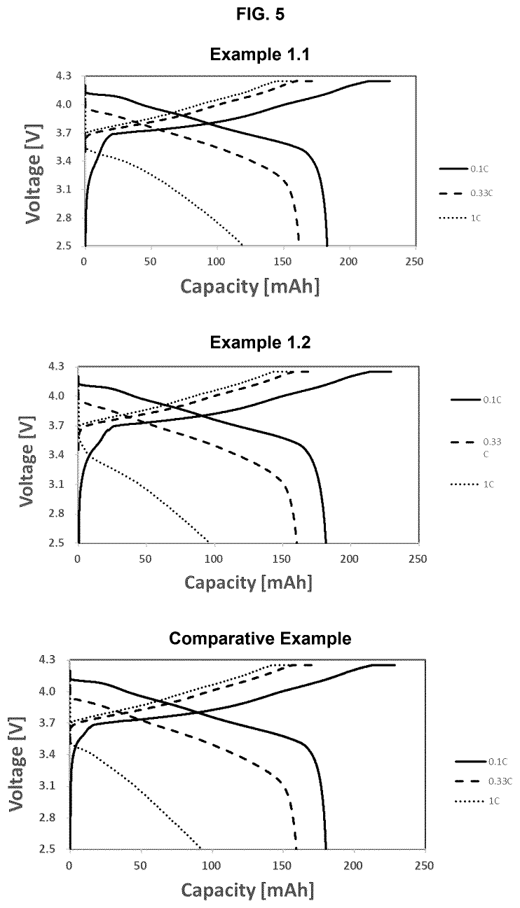

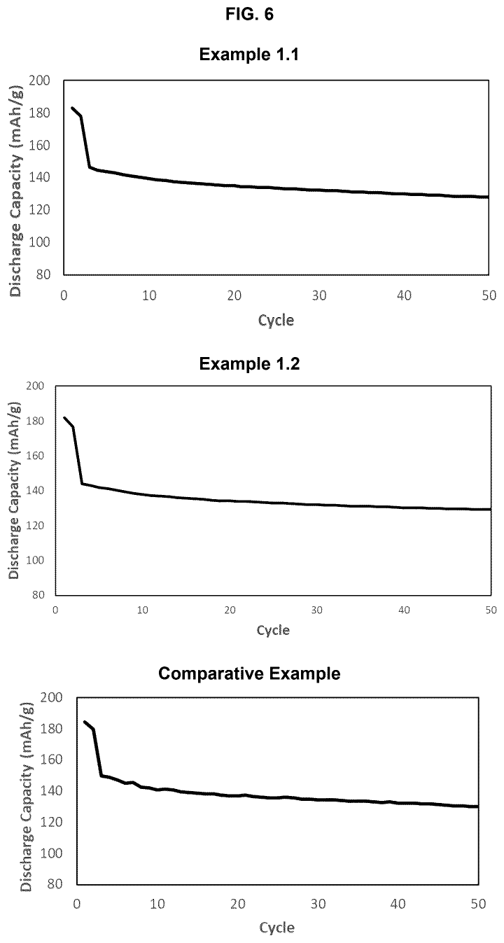

FIG. 5 shows the results of rate tests for the solid state batteries of Example 1.1, Example 1.2 and the Comparative Example. FIG. 6 shows the results of cycling tests for the solid state batteries of Example 1.1, Example 1.2 and the Comparative Example.

According to a first embodiment, an anode-free metal battery includes a positive electrode, a solid-state electrolyte separator, and a negative electrode coated with a metal/metalloid particle decorated carbon.

According to a second embodiment, the metal/metalloid nanoparticle decorated carbon consists of metal/metalloid nanoparticles of silver, gold, platinum, tellurium, antimony, germanium, bismuth, tin, tungsten, molybdenum, cobalt, nickel, copper or combination thereof. The soluble metal precursors consisted of the metal cations and the anions selected from nitrate, nitrite, thiosulfate, hydroxide, carbonate, acetate, oxalate, maleate. The precursor(s) is mixed with the carbon, the polyacids and LiOH—H₂O (pH adjusting agent) in a solvent to form a suspension that is coated onto a metal foil. The metal foil will serve as the anode current collector for the anode-free metal battery.

According to a third embodiment, the metal or metalloid alloy nanoparticle size is less than 10 nm, and the metal to carbon ratio is between 2 wt % to 30 wt %.

According to a fourth embodiment, the carbon of the second embodiment is selected from the amorphous carbon.

According to a fifth embodiment, the polyacids of the second embodiment are selected from poly-acrylic acid, polymethacrylic acid, polymaleic acid, polyglutamic acid, polyitaronic acid, poly styrene carboxylic acid, poly(methyl vinyl ether-altmaleic acid), poly(styrene-alt-maleic acid), poly(malic acid), poly(metaphosphoric acid), polyvinyl sulfonic acid, polystyrene sulfonic acid, poly(styrene sulfonic acid-alt-maleic acid), poly(vinyloxy-4-butyric acid), poly(vinyl-phenyl boronic acid) or combination thereof, and the coblock polymers between the polyacids with poly ethylene glycol, poly propylene glycol, and polydimethylsiloxane. The polyacids and polyacid co-block polymers have a molecular weight of greater than 60,000.

According to a sixth embodiment, the solvent of the second embodiment is selected from water, ethanol, isopropanol and NMP.

According to a seventh embodiment, the metal foil of the second embodiment is selected from stainless steel, Fe, Ni, Mn, Cu and Ti.

According to an eight embodiment, the metal/metalloid decorated carbon coating of the second embodiment is 1 micron to 30 micron thick.

According to a ninth embodiment, the solid electrolyte material may include Li2S—P2S5, Li2S—P2S5-LiX (where X is a halogen atom, e.g., I or Cl), Li2S—P2S5-Li2O, Li2S—P2S5-Li2O—LiI, Li2S—SiS2, Li2S—SiS2-LiI, Li2S—SiS2-LiBr, Li2S—SiS2-LiCl, Li2S—SiS2-B2S3-LiI, Li2S—SiS2-P2S5-LiI, Li2S—B2S3, Li2S—P2S5-ZmSn (where m and n are positive integers and Z is Ge, Zn, or Ga), Li2S—GeS2, Li2S—SiS2-Li3PO4, or Li2S—SiS2-LipMOq (where p and q are positive integers and M is P, Si, Ge, B, Al, Ga, or In).

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

What is claimed is:

1. A nanocomposite interlayer comprising:
a carbonaceous material;
nanoparticles comprising metals or metalloids;
at least one polymer binder; and
a pH adjusting agent.

2. The nanocomposite interlayer of claim 1, wherein the carbonaceous material comprises amorphous carbon, graphite, graphene, reduced graphene oxide, carbon nanotube, or combinations thereof.

3. The nanocomposite interlayer of claim 1, wherein the nanoparticles comprise silver, gold, platinum, tellurium, antimony, germanium, bismuth, tin, tungsten, molybdenum, cobalt, nickel, copper, iron, alloys of at least two thereof, and combinations thereof.

4. The nanocomposite interlayer of claim 1, wherein the polymer binder comprises
at least one selected from among Formula (IA), Formula (IB), Formula (IC), and Formula (ID), or
a co-block polymer comprising: at least two repeating units selected from among polyethylene glycol, polypropylene glycol, and polydimethylsiloxane; and at least one selected from among Formula (IA), Formula (IB), Formula (IC), and Formula (ID), 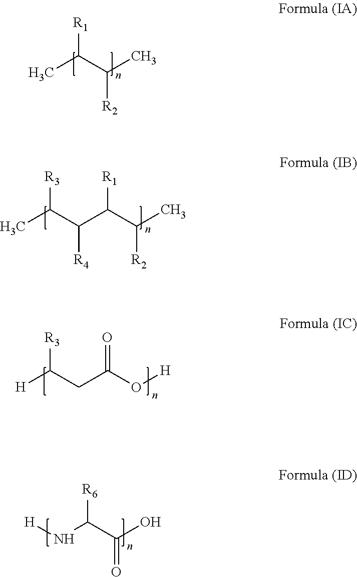
wherein,
n is an integer from 1 to about 200,
each R₁ is independently —H, —COOH, —OH, —SO₃H, —BO₂H₂, —PO₃H₂, —C_{z}H_{2z+1}, —OC_{z}H_{2z+1}, —OC_{z}H_{2z}COOH, or Ar₁,
Ar₁ is selected from among phenyl, 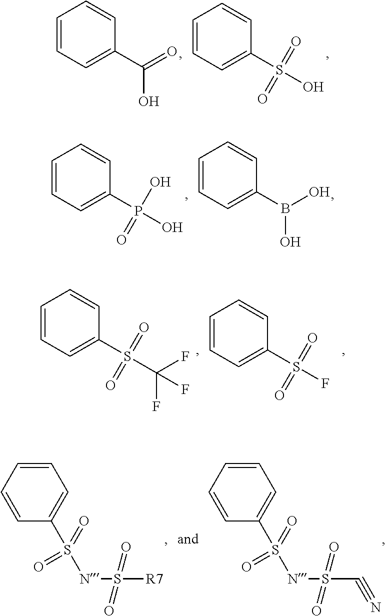
and a ring-forming carbon atom of Ar₁ not connected to a heteroatom or a carboxylate is connected to Formula (IA) or (IB),
when R₁ is not —C_{z}H_{2z+1}, —OC_{z}H_{2z+1}, or phenyl, each R₂ is independently —H or —COOH,
each R₃ is independently —H, —OH, —OC_{z}H_{2z+1}, or phenyl,
when R₃ is —H, each R₄ is independently —OH, —OC_{z}H_{2z+1}, or phenyl,
when R₃ is not —H, each R₄ is —H,
each R₅ is independently —COOH, —SO₃H, —BO₂H₂, —PO₃H₂, or Ar₂,
Ar₂ is selected from among 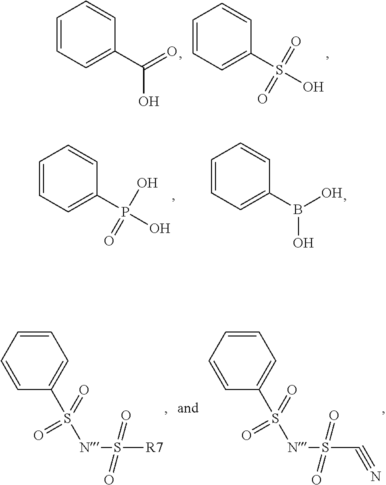
and a ring-forming carbon atom of Ar₂ not connected to a heteroatom or a carboxylate is connected to Formula (IC),
R₇ is C_{z}X_{2z+1} and each X is independently H, F, Cl, or Br,
each z is independently at least 1,
each R₆ is independently —CₘH₂ₘCOOH, —CₘH₂ₘCONHCₚH₂ₚCOOH, —CₘH₂ₘCONH₂, or —CₚH₂ₚNH₂,
each m is independently 1 or 2, and
each p is independently greater than or equal to 1.

5. A battery comprising:
a positive electrode;
a negative electrode current collector;
a nanocomposite interlayer on the negative electrode current collector and comprising
a carbonaceous material,
nanoparticles comprising metals or metalloids,
at least one polymer binder, and
a pH adjusting agent; and
an electrolyte between the positive electrode and the nanocomposite interlayer,
wherein the battery is an anodeless battery.

6. The battery of claim 5, wherein the carbonaceous material comprises amorphous carbon, graphite, graphene, reduced graphene oxide, carbon nanotube, or combinations thereof.

7. The battery of claim 5, wherein the nanoparticles comprise silver, gold, platinum, tellurium, antimony, germanium, bismuth, tin, tungsten, molybdenum, cobalt, nickel, copper, iron, alloys of at least two thereof, and combinations thereof.

8. The battery of claim 5, wherein an average particle diameter of the nanoparticles is at most about 10 nanometer (nm).

9. The battery of claim 5, wherein a weight ratio of the nanoparticles to the carbonaceous material is about 1 to about 50.

10. The battery of claim 5, wherein a thickness of the nanocomposite interlayer is about 1 micrometer (μm) to about 30 μm.

11. The battery of claim 5, wherein the nanocomposite interlayer comprises the nanocomposite interlayer of claim 1.

12. The battery of claim 5, wherein the polymer binder has an average molecular weight of at least about 60,000 Dalton (D).

13. The battery of claim 5, wherein the pH adjusting agent comprises a base.

14. The battery of claim 5, wherein the negative electrode current collector comprises a metal foil comprising stainless steel, iron, nickel, manganese, copper, titanium, aluminum, or combinations thereof.

15. The battery of claim 14, wherein the negative electrode current collector comprises an amount of unspecified trace elements of less than about 1%.

16. The battery of claim 5, wherein the nanocomposite interlayer is between the negative electrode current collector and the electrolyte.

17. The battery of claim 5, wherein the battery comprises a transitory negative electrode between the nanocomposite interlayer and the negative electrode current collector.

18. A method of operating the battery of claim 1 comprising:
charging the battery to form a transitory negative electrode between the nanocomposite interlayer and the negative electrode current collector.

19. A method of operating the battery of claim 18 comprising:
discharging the battery to remove the transitory negative electrode.

20. The method of claim 18, wherein the transitory negative electrode comprises metal elements, metal alloys, metal compounds, or combinations thereof.
